(19) United States
(12) Patent Application Publication
(10) Pub. No.: US 2023/0211823 A1
(43) Pub. Date: Jul. 6, 2023

(54) STEERING GEAR FOR A VEHICLE HAVING A HELICAL GEAR, AND STEERING SYSTEM HAVING SUCH A STEERING GEAR

(71) Applicant: ZF Friedrichshafen AG, Friedrichshafen (DE)

(72) Inventor: Torsten Hesse, Oberteuringen (DE)

(73) Assignee: ZF Friedrichshafen AG, Friedrichshafen (DE)

(21) Appl. No.: 18/149,940

(22) Filed: Jan. 4, 2023

(30) Foreign Application Priority Data
Jan. 5, 2022 (DE) 102022200072.2

(51) Int. Cl. B62D 5/00; B62D 5/04; F16H 1/18; F16H 55/08

(52) U.S. Cl. CPC B62D 5/001; B62D 5/0409; B62D 5/0421; F16H 1/18; F16H 55/082

(57) ABSTRACT

The invention relates to a steering gear (11) for a vehicle having a helical gear (19), the helical gear (19) having a first gear wheel (21) and a second gear wheel (22) which engages with the first gear wheel (21), a first rotation axis (23) of the first gear wheel (21) being aligned so as to be transverse to a second rotation axis (24) of the second gear wheel (22), and an axis perpendicular (25) being aligned so as to be orthogonal to the first rotation axis (23) and to the second rotation axis (24), a smallest spacing between axes (26) between the first rotation axis (23) and the second rotation axis (24) coinciding with the axis perpendicular (25), and an engagement line (33) resulting by means of common contact points (34) of the two mutually engaged gear wheels (21, 22). In order to increase the diversity in terms of variants and/or to improve the adaptation possibilities, the steering gear (11) is characterized in that the engagement line (33) is spaced apart from the axis perpendicular (25).

The invention relates to a steering gear for a vehicle having a helical gear, the helical gear having a first gear wheel and a second gear wheel which engages with the first gear wheel, a first rotation axis of the first gear wheel being aligned so as to be transverse to a second rotation axis of the second gear wheel, and an axis perpendicular being aligned so as to be orthogonal to the first rotation axis and to the second rotation axis, a smallest spacing between axes between the first rotation axis and the second rotation axis coinciding with the axis perpendicular, and an engagement line resulting by means of common contact points of the two mutually engaged gear wheels. The invention furthermore relates to a steering system having such a steering gear and having an electric motor which is connected in a torque-transmitting manner to the steering gear.

A steering gear of this type, or such a steering system, respectively, is substantially known from DE 10 2021 205 253 A1.

Corresponding steering gears typically employ such helical gears which are configured by means of predetermined standards or theories. This includes the engagement line intersecting the axis perpendicular, in particular in a bolting point.

However, it is disadvantageous here that, owing to the engagement line having to intersect the axis perpendicular, the possibilities for conceiving and/or optimizing the helical gear are restricted. For example, increases in terms of load that arise only in the later operation can only be compensated for by way of higher-quality and/or more expensive materials. Alternatively, the requirements, in particular in the context of a performance specification, have to be reduced owing to deficiencies in terms of the adaptation possibilities of the helical gear.

Therefore, the object on which the invention is based lies in refining a steering gear and/or a steering system of the type mentioned at the outset in such a manner such that the diversity in terms of variants is increased and/or the adaptation possibilities are improved. An alternative embodiment is to be provided in particular.

The object on which the invention is based is achieved by a steering gear as claimed in claim 1 and/or by means of a steering system as claimed in claim 10. Preferred refinements of the invention are to be found in the dependent claims and in the description hereunder.

Accordingly, a steering gear for a vehicle, in particular a motor vehicle, has a helical gear. The helical gear has a first gear wheel and a second gear wheel which engages with the first gear wheel. A first rotation axis of the first gear wheel here is aligned so as to be transverse to a second rotation axis of the second gear wheel. The first gear wheel is preferably rotatable about the first rotation axis, and the second gear wheel is rotatable about the second rotation axis. A pairing of the first gear wheel and the second gear wheel having mutually intersecting rotation axes can be referred to as a helical gear. The helical gear is distinguished in particular by a compact construction mode. High gear ratios can be implemented, by way of which rotating movements and torques can be positively geared and transmitted. The gear wheels are in particular helically geared and/or have involute teeth and/or tooth flanks. The two rotation axes can be aligned so as to be mutually orthogonal or skewed. The two rotation axes are in particular aligned so as to be mutually orthogonal, or at a mutual angle of 90°, respectively.

An axis perpendicular is aligned so as to be orthogonal to the first rotation axis and to the second rotation axis. A smallest spacing between axes between the first rotation axis and the second rotation axis here coincides with the axis perpendicular. In this way, the spacing between axes corresponds to the shortest spacing between the two rotation axes.

An engagement line results by means of common contact points of the two mutually engaged gear wheels. A locus curve of the common contact points of the two gear wheels is in particular referred to as the engagement line. The engagement line in the contact points is preferably orthogonal to tooth flanks of teeth of the gear wheels. The engagement line results in particular as an intersection between a first engagement plane of the first gear wheel and a second engagement plane of the second gear wheel.

According to the invention, the engagement line is spaced apart from the axis perpendicular.

It is advantageous here that, by dispensing with the hitherto customary requirement according to which the engagement line must intersect the axis perpendicular, the adaption possibilities for conceiving the helical gear are increased or improved. By virtue of the engagement line being spaced apart from the axis perpendicular, additional variants of basic design are derived, as a result of which it is possible for the helical gear to be optimized. In the case of a spacing between the engagement line and the axis perpendicular, the load-bearing capability of the helical gear, of the first gear wheel and/or of the second gear wheel is increased in particular. A tooth base load bearing capability and/or wear-resistance capability can be increased by virtue of the engagement line being spaced apart from the axis perpendicular. By virtue of the basic design of the helical gear, such that the engagement line is spaced apart from the axis perpendicular, a tooth root tension on teeth of the first gear wheel and/or of the second gear wheel can be reduced in particular.

According to a further embodiment, the engagement line is spaced apart from the axis line by way of a minimum spacing. The minimum spacing is in particular greater than zero. The minimum spacing is preferably specified as value. The minimum spacing preferably specifies the smallest, shortest and/or slightest spacing of the engagement line from the axis perpendicular.

The minimum spacing is preferably greater than 0.1 mm or greater than 0.2 mm. The minimum spacing is in particular greater than a spacing between the engagement line and the axis perpendicular that results in the case of permissible variances in a basic design of a helical gear not according to the invention, in which the engagement line is intended to intersect the axis perpendicular.

According to a refinement, the minimum spacing is less than 2 mm or less than 1.5 mm. the minimum spacing is in particular at most 2 mm. in this way, the smallest and/or slightest spacing of the engagement line from the axis perpendicular can be less than 2 mm or less than 1.5 mm.

The minimum spacing is in particular in a predefined range. The minimum spacing can be in a range from 0.1 mm to 2 mm. the minimum spacing is preferably in the range from 0.2 mm to 2 mm, or in a range from 0.2 mm to 1.5 mm.

According to a further embodiment, the minimum spacing between the engagement line and the axis perpendicular results as a straight line between the engagement line and the axis perpendicular. The straight line here is aligned so as to be orthogonal to the engagement line and orthogonal to the axis perpendicular. As a result, the minimum spacing describes the slightest spacing between the engagement line and the axis perpendicular.

The axis perpendicular can coincide with a z-axis of a three-dimensional Cartesian coordinate system which is formed by means of an x-axis, a y-axis and a z-axis. The x-axis and the y-axis are in particular mutually orthogonal, the z-axis being orthogonal to the x-axis as well as to the y-axis. The x-axis, the y-axis and the z-axis intersect one another in a common point of origin of the coordinate system. The engagement line intersects the x-axis in a first intersection point and intersects the y-axis in a second intersection point. As opposed to a helical gear not according to the invention, in which the engagement line intersects the axis perpendicular, in particular in a single bolting point on the z-axis, the engagement line according to the invention intersects the xz-plane as well as the yz-plane in each case in one intersection point with a z-coordinate unequal to zero. At least in a projection of the engagement line onto an xy-plane, the engagement line can intersect the x-axis in a first intersection point and intersect the y-axis in a second intersection point. In particular, the x-axis and the z-axis lie in the xz-plane, the y-axis and the z-axis lie in the yz-plane, and the x-axis and the y-axis lie in the xy-plane. In comparison to the helical gear not according to the invention, there is no bolting point, in particular no bolting point that lies on the z-axis, in the helical gear according to the invention.

The axes spacing coincides in particular with the z-axis. The first rotation axis and the second rotation axis preferably intersect the z-axis.

According to one refinement, the engagement line is spaced apart from the axis perpendicular by virtue of the geometry of the first gear wheel. This adaption of the first gear wheel preferably takes place in comparison to or in relation to a helical gear in which an engagement line not according to the invention intersects the axis perpendicular. In order for the engagement line to be spaced apart from the axis perpendicular, a real pitch module and/or an engagement angle and/or a helix angle of the first gear wheel is adapted or changed in particular.

The second gear wheel is preferably unchanged. The second gear wheel is particularly unchanged in comparison to or in relation to a second gear wheel in a helical gear in which the engagement line intersects the axis perpendicular. The load-bearing capability of the second gear wheel can be increased by virtue of the adaptation of the first gear wheel and/or of the housing such that the engagement line is spaced apart from the axis perpendicular.

According to one refinement, the engagement line is spaced apart from the axis perpendicular by virtue of an adaptation of the geometry of the second gear wheel. This adaptation of the second gear wheel preferably takes place or results in comparison to or in relation to a helical gear in which an engagement line not according to the invention intersects the axis perpendicular. In order for the engagement line to be spaced apart from the axis perpendicular, a real pitch module and/or an engagement angle and/or a helix angle of the second gear wheel is adapted or changed in particular.

According to a further embodiment, the engagement line is spaced apart from the axis perpendicular by virtue of an adaptation of the geometry of the first gear wheel and of the second gear wheel. In order for the engagement line to be spaced apart from the axis perpendicular, a real pitch module and/or an engagement angle and/or a helix angle of the first gear wheel and of the second gear wheel can be adapted or changed.

The first gear wheel has in particular at least one tooth or a plurality of teeth which is/are disposed at a first helix angle in relation to the first rotation axis. The second gear wheel preferably has at least one tooth or a plurality of teeth which is/are disposed at a second helix angle in relation to the second rotation axis.

The toothing of the helical gear is in particular configured as an involute toothing. Accordingly, the first gear wheel and the second gear wheel have in each case involute tooth flanks.

A housing for receiving and/or mounting the helical gear, in particular an axes intersection angle and/or the axes spacing between the first rotation axis and the second rotation axis, is preferably unchanged in terms of the adaptation of the geometry of the first gear wheel and/or of the second gear wheel. The housing, the axes intersection angle and/or the axes spacing, are/is in particular unchanged in comparison to or in relation to a housing in a helical gear in which the engagement line intersects the axis perpendicular.

The housing, by virtue of a rotatable mounting of the first gear wheel and of the second gear wheel on the housing, can determine or predefine the axes spacing between the first rotation axis and the second rotation axis. The axes intersection angle results in particular as an angle between the two rotation axes of the first gear wheel and of the second gear wheel that intersect in a plan view from above. The housing, by virtue of a rotatable mounting of the first gear wheel and of the second gear wheel on the housing, can determine or predefine the axes intersection angle.

According to a further embodiment, a housing that receives and/or mounts the helical gear in terms of the reception and/or mounting of the helical gear is adapted for spacing apart the engagement line from the axis perpendicular. The axes intersection angle and/or the axes spacing between the first rotation axis and the second rotation axis for spacing apart the engagement line from the axis perpendicular is in particular adapted by means of the design of the housing.

According to a further embodiment, the engagement line is spaced apart from the axis perpendicular by virtue of an adaptation of the geometry of the first gear wheel and of the second gear wheel and of the housing.

The first gear wheel is preferably configured as a first spur wheel, and the second gear wheel is preferably configured as a second spur wheel. In particular, the first gear wheel is configured as a helical pinion, and the second gear wheel is configured a helical gear. The gear wheel having the lower tooth count here can be the helical pinion, and the gear wheel having the higher tooth count can be the helical gear. Driving the helical gear usually takes place by way of the helical pinion. The helical pinion here can be driven and/or connected by means of an electric motor.

A steering system having a steering gear according to the invention, and an electric motor which is connected in a torque-transmitting manner to the helical gear is particularly advantageous. The steering system is configured in particular as an electromechanically assisted steering system. The helical gear is configured in particular as a servo-electric helical gear.

The steering system can have an electromechanical steering assistance with an electric motor and the steering gear. In this way, the steering system can configure an electric servo assistance for steering a vehicle or a motor vehicle. The electromechanical steering assistance can provide an auxiliary force which generates a supporting torque when steering. As a result, a steering torque to be applied by a driver to a steering wheel or a steering column can be reduced. The steering system can be configured as an electronic power steering system (EPS) or as a steer-by-wire (SbW) steering system.

The first gear wheel, in particular in the configuration as a helical pinion, is able to be driven by means of the electric motor. The torque is able to be transmitted to the second gear wheel, preferably in the configuration as a helical gear, by means of the first gear wheel. The torque from the helical gear can be transmitted to a steering link or a rack or a steering column. The steering link and/or the rack and/or the steering column are preferably component parts of the steering system and/or of the steering gear.

The steering system is preferably refined according to the design embodiments explained in the context of the steering gear according to the invention described here. Furthermore, the steering gear described here can be refined according to the design embodiments explained in the context of the steering system.

The invention will be explained in more detail hereunder by means of the figures. The same reference signs here relates to an identical, similar or functionally equivalent components or elements. In the figures:

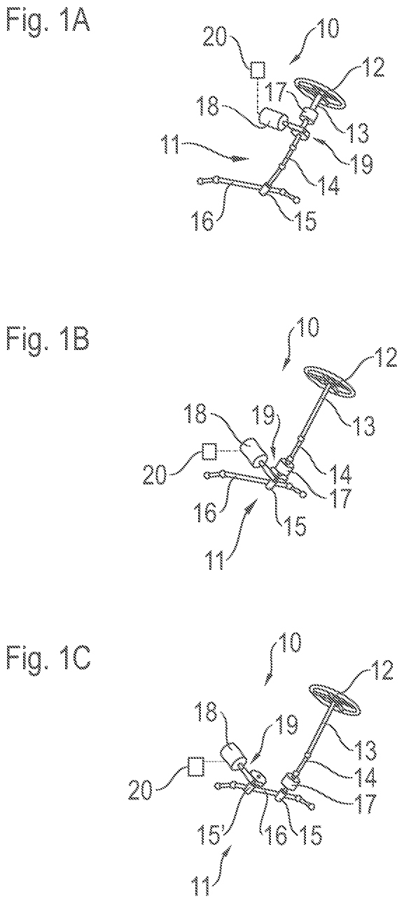

FIG. 1 in sub-figures a), b) and c) shows in each case a variant of a steering system according to the invention in a schematic and perspective lateral view;

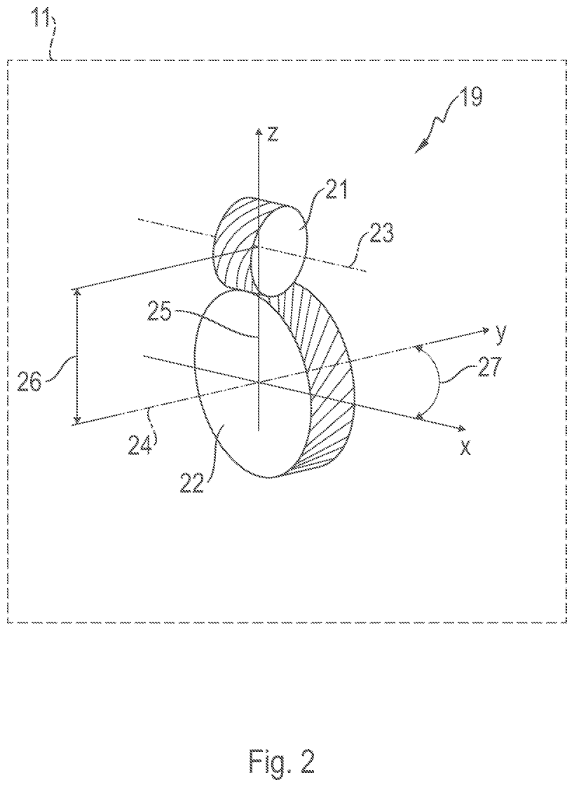

FIG. 2 shows a first schematic, perspective lateral view of a steering gear according to the invention;

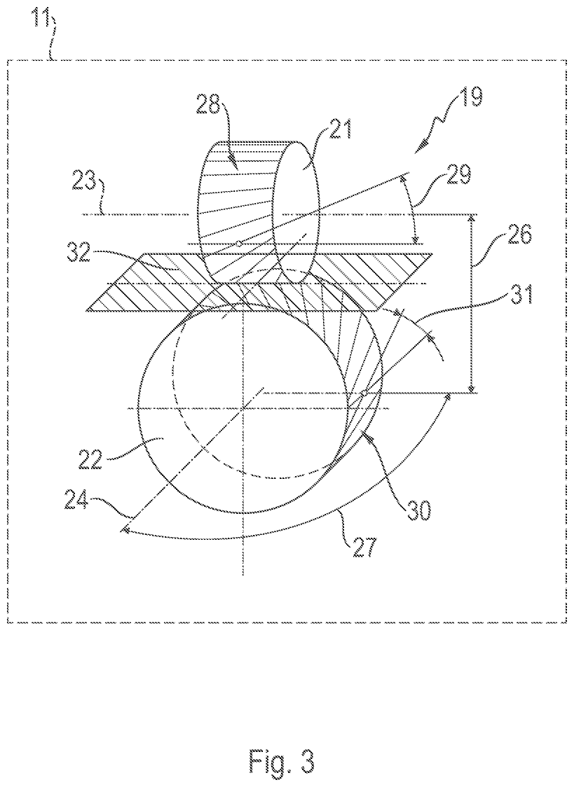

FIG. 3 shows a second schematic, perspective lateral view of the steering gear according to the invention;

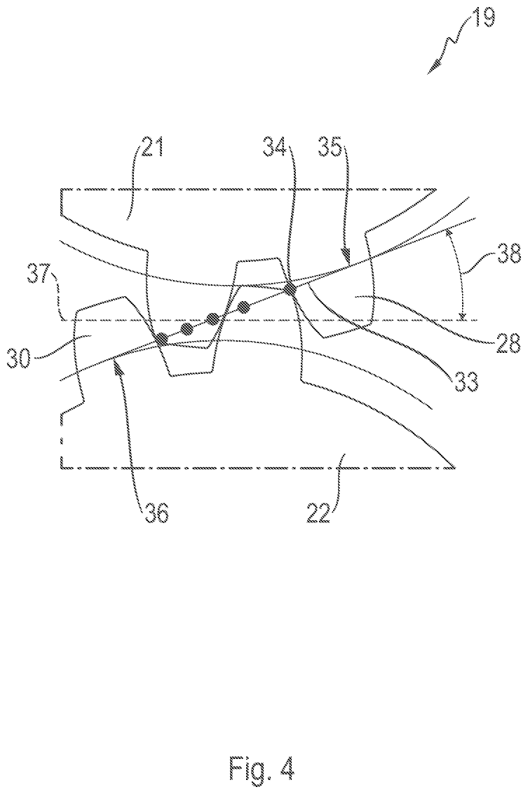

FIG. 4 shows a fragment of a sectional, schematic lateral view of a helical gear, for visualizing the engagement line; and

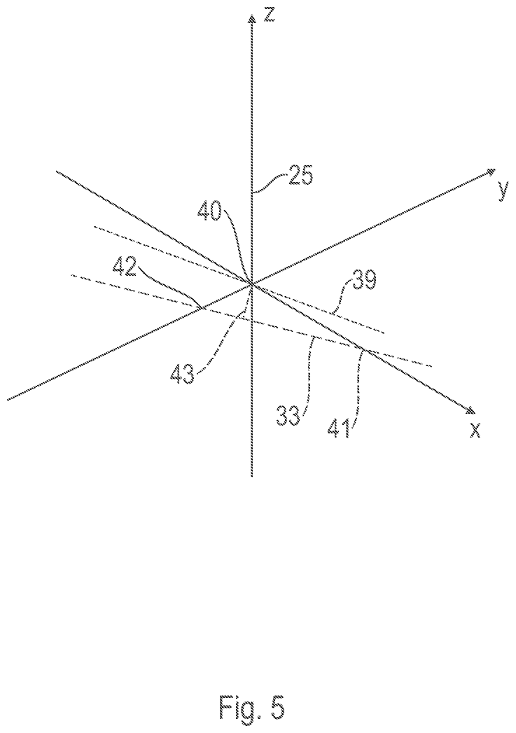

FIG. 5 shows a schematic illustration of the profile of a first engagement line for the steering gear according to the invention and of the second engagement line for a steering gear not according to the invention.

FIG. 1 in sub-figure a) schematically shows a steering system 10 for a motor vehicle, wherein the steering system 10 has a steering gear 11. In this exemplary embodiment, the steering system 10 is embodied as an electromechanically assisted steering system 10 with steering column assistance (also referred to as column drive EPS).

The steering system 10 has a steering wheel 12 which by way of an upper part of the steering column 13, and in this exemplary embodiment by way of the steering layshaft 14, is connected to a pinion 15. The pinion 15 meshes with a rack 16 such that the latter is impinged by a torque.

In this exemplary embodiment, a torque and/or steering angle sensor 17 is disposed on the steering column 13, said torque and/or steering angle sensor 17 being configured for measuring steering torques and/or a steering angle. This is thus in particular a steering torque and steering angle sensor which is also referred to as a “torque and angle sensor (TAS)” and, in addition to the steering torque, can provide a steering angle.

Furthermore provided is an electric motor 18 which is connected in a torque-transmitting manner to a helical gear 19. The helical gear 19 is a component part of the steering gear 11.

A torque which is provided by the electric motor 18 for carrying out a steering movement, can be transmitted to the steering layshaft 14 by means of the helical gear 19.

The electric motor 18 in this exemplary embodiment is connected in a signal-transmitting manner to a control apparatus 20 of the steering system 10. The control apparatus 20, based on measured data from the steering system 10, is configured to at least determine a torque to be applied and to relay corresponding control commands to the electric motor 18 such that the electric motor 18 provides the torque to be applied.

The control apparatus 20 can furthermore be configured to control, in particular to steer the motor vehicle having the steering system 10 at least in a partially automatic, in particular fully automatic, manner. In this case, not only an assisting torque is provided by the electric motor 18 but rather the entire torque required for controlling or steering the motor vehicle, respectively.

The steering system 10 shown in sub-figure b) differs from that in sub-figure a) in that the electric motor 18 by way of the helical gear 19 is connected in a torque-transmitting manner not to the steering layshaft 14 but to the pinion 15. The steering system 10 thus has a simple pinion drive, this also be referred to as a “single pinion EPS”.

The steering system 10 shown in sub-figure c), in addition to the first pinion 15, has a second pinion 15′ which meshes with the rack 16. The electric motor 18 is connected in a torque-transmitting manner to the second pinion 15′ by way of the helical gear 19. The steering system 10 in this case is thus a steering system having a double pinion, this also being referred to as a “dual pinion EPS”.

FIG. 2 shows a first schematic, perspective lateral view of a steering gear 11 according to the invention, as is illustrated by way of example in the steering systems 10 of FIG. 1. The helical gear 19 of the steering gear 11 here is schematically illustrated.

The helical gear 19 has a first gear wheel 21 and a second gear wheel 22 which engages with the first gear wheel 21. In this exemplary embodiment, the first gear wheel 21 is configured as a helical pinion, and the second gear wheel 22 is configured as a helical gear.

A first rotation axis 23 of the first gear wheel 21 is transverse to a second rotation axis 24 of the second gear wheel 22. In this exemplary embodiment, the first rotation axis 23 is aligned so as to be orthogonal to the second rotation axis 24. An axes intersection angle 27 here is thus 90°.

An axis perpendicular 25 here is aligned so as to be orthogonal to the first rotation axis 21 and to the second rotation axis 22. A slightest axes spacing 26 between the first rotation axis 21 and the second rotation axis 22 here coincides with the axis perpendicular 25.

In addition, an x-axis, a y-axis and a z-axis of a three-dimensional Cartesian coordinate system are plotted here in such a manner that the axis perpendicular 25 coincides with the z-axis. Moreover, in this exemplary embodiment the first rotation axis 23 is aligned so as to be parallel to the x-axis and spaced apart from the x-axis by the axes spacing 26. The second rotation axis 24 here coincides with the y-axis.

Since the axes intersection angle 27 here by way of example is 90°, the axes intersection angle 27 in this exemplary embodiment can also be represented by virtue of the 90° angle between the x-axis and the y-axis.

The gear wheels 21, 22 can be disposed so as to be rotatably mounted in a housing which is not illustrated in more detail here. The axes spacing 26 between the first rotation axis 23 and the second rotation axis 24 can be predefined by virtue of the rotatable mounting of the first gear wheel 21 and of the second gear wheel 22 on such a housing. Moreover, the housing, by virtue of the rotatable mounting of the first gear wheel 21 and of the second gear wheel 22 on the housing, can predefine the axes intersection angle 27.

FIG. 3 shows a second schematic, perspective lateral view of the steering gear in 11 according to the invention, similar to that of FIG. 2. Identical features are provided with the same reference signs as above. To this extent, reference is made to the preceding description in order to avoid repetitions.

The first gear wheel 21 has a plurality of teeth 28 which are only schematically indicated. The teeth 28 are in each case disposed at a first helix angle 29 in relation to the first rotation axis 23. The second gear wheel 22 here likewise has a plurality of teeth 30 which are only schematically indicated and are disposed at a second helix angle 31 in relation to the second rotation axis 24. The toothing of the helical gear 19, or of the tool gear wheels 21, 22, respectively, here is configured as an involute toothing, which is not illustrated in more detail.

Additionally illustrated here is a face gear plane 32. As is schematically illustrated hereunder, the two gear wheels 21, 22 contact one another at contact points of which the locus curve is referred to as the engagement line.

FIG. 4 shows a fragment of a sectional, schematic lateral view of the helical gear 19, for visualizing the engagement line 33.

It can be seen that the teeth 28, 30 of the two gear wheels 21, 22 contact one another at contact points 34. The engagement line 33 is formed by means of the common contact points 34 of the two mutually engaged gear wheels 21, 22. By way of example, only a few contact points 34 are schematically illustrated on the engagement line 33 here. For the sake of improved clarity, not all of the contact points 34 are provided with a reference sign.

The engagement line 34 at the contact point 33 is perpendicular to the tooth flanks of the teeth 28, 30, said contact 33 being created by virtue of contact between the two teeth 28, 30. The engagement line 34 here touches tangentially in each case a first base circle 35 of the first gear wheel 21 and a second base circle 36 of the second gear wheel 22. An engagement angle 38 results between the engagement line 33 and a line 37. The line 37 here results as a normal in relation to the axis perpendicular 25 according to FIG. 2.

FIG. 5 shows a schematic illustration of a profile of a first engagement line 33 for the steering gear 11 according to the invention, and of a second engagement line 39 for a steering gear not according to the invention.

It can be seen that the engagement line 33 according to the solution according to the invention, and as opposed to the engagement line 39 according to an embodiment not according to the invention, is spaced apart from the axis perpendicular 25. in this exemplary illustration the axis perpendicular 25 coincides with the z-axis of a three-dimensional Cartesian coordinate system.

The engagement line 39 not according to the invention intersects the axis perpendicular at a bolting point 40 that lies on the z-axis and in this exemplary embodiment simultaneously coincides with the origin of the coordinate system.

In contrast, the engagement line 33 according to the invention does not intersect the bolting point 40, or the z-axis, respectively. Instead, the engagement line 33 intersects an xz-plane having a first intersection point 41 and a yz-plane having a second intersection point 42. In this exemplary embodiment, the engagement line 33 intersects the x-axis in the first intersection point 41, and intersects the y-axis in the second intersection point 42.

The engagement line 33 is spaced apart from the axis perpendicular 25 by a minimum spacing 43. The minimum spacing 43 between the engagement line 33 and the axis perpendicular 25 results as a straight line, wherein the straight line is aligned so as to be orthogonal to the engagement line 33 and orthogonal to the axis perpendicular 25.

The value of the minimum spacing 43 in this exemplary embodiment is greater than 0.2 mm.

In comparison to a solution not according to the invention, having the engagement line 39, the engagement line 33 can be implemented by means of an adaptation of the geometry of the first gear wheel 21 for example. To this end, the real pitch module and/or the engagement angle 38 and/or the first helix angle 29, for example, can be changed.

### LIST OF REFERENCE SIGNS

10 Steering system

11 Steering gear

12 Steering wheel

13 Steering column

14 Steering layshaft

15, 15′ Pinion

16 Rack

17 Torque and/or steering angle sensor

18 Electric motor

19 Helical gear

20 Control apparatus

21 First gear wheel

22 Second gear wheel

23 First rotation axis

24 Second rotation axis

25 Axis perpendicular

26 Spacing between axes

27 Axes intersection angle

28 Tooth

29 First helix angle

30 Tooth

31 Second helix angle

32 Face gear plane

33 Engagement line (according to the invention)

34 Contact points

35 First base circle

36 Second base circle

37 Line

38 Engagement angle

39 Engagement line (not according to the invention)

40 Bolting point

41 First intersection point

42 Second intersection point

43 Minimum spacing

1. A steering gear for a vehicle having a helical gear (19), the helical gear (19) having a first gear wheel (21) and a second gear wheel (22) which engages with the first gear wheel (21), a first rotation axis (23) of the first gear wheel (21) being aligned so as to be transverse to a second rotation axis (24) of the second gear wheel (22), and an axis perpendicular (25) being aligned so as to be orthogonal to the first rotation axis (23) and to the second rotation axis (24), a smallest spacing between axes (26) between the first rotation axis (23) and the second rotation axis (24) coinciding with the axis perpendicular (25), and an engagement line (33) resulting by means of common contact points (34) of the two mutually engaged gear wheels (21, 22), wherein the engagement line (33) is spaced apart from the axis perpendicular (25).

2. The steering gear as claimed in claim 1, wherein the engagement line (33) is spaced apart from the axis perpendicular (25) by way of a minimum spacing (34), the minimum spacing (34) being in particular greater than zero.

3. The steering gear as claimed in claim 2, wherein the minimum spacing (34) is greater than 0.1 mm or greater than 0.2 mm, the minimum spacing (34) preferably being less than 2 mm or less than 1.5 mm, the minimum spacing (34) being in particular at most 2 mm.

4. The steering gear as claimed in one of claims 2 to 3, wherein the minimum spacing (43) between the engagement line (33) and the axis perpendicular (25) results in a straight line between the engagement line (33) and the axis perpendicular (25), the straight line being aligned so as to be orthogonal to the engagement line (33) and orthogonal to the axis perpendicular (25).

5. The steering gear as claimed in one of the preceding claims, wherein the axis perpendicular (25) coincides with a z-axis of a three-dimensional Cartesian coordinate system having an x-axis, a y-axis and a z-axis, the engagement line (33) intersecting an xz-plane in a first intersection point (41) and a yz-plane in a second intersection point (42), the first rotation axis (32) and the second rotation axis (24) intersecting in particular the z-axis.

6. The steering gear as claimed in one of the preceding claims, wherein the engagement line (33) is spaced apart from the axis perpendicular (25) by virtue of an adaptation of the geometry of the first gear wheel (21) and/or of the second gear wheel (22), a real pitch module and/or an engagement angle (38) and/or a helix angle (29) of the first gear wheel (21) and/or of the second gear wheel (22) being in particular adapted for spacing apart the engagement line (33) from the axis perpendicular (25), the adaptation in comparison to a helical gear taking place in particular in that an engagement line not according to the invention (39) intersects the axis perpendicular (25).

7. The steering gear as claimed in one of the preceding claims, wherein a housing that receives and/or mounts the helical gear (19) in terms of the reception and/or mounting of the helical gear (19) is adapted for spacing apart the engagement line (33) from the axis perpendicular (25), an axes intersection angle (27) and/or the spacing between axes (26) between the first rotation axis (23) and the second rotation axis (24) being adapted for spacing apart the engagement line (33) from the axis perpendicular (25) in particular by means of the design of the housing.

8. The steering gear as claimed in claim 6, wherein a housing that receives and/or mounts the helical gear (19), in particular an axes intersection angle (27) and/or the spacing between axes (26) between the first rotation axis (23) and the second rotation axes (24), are/is unchanged in terms of the adaptation of the geometry of the first gear wheel (21), the second gear wheel (22) preferably being unchanged.

9. The steering gear as claimed in one of the preceding claims, wherein the first gear wheel (21) is configured as a first spur wheel, and the second gear wheel (22) is configured as a second spur wheel, the first gear wheel (21) being configured in particular as a helical pinion and the second gear wheel (22) being configured in particular as a helical gear.

10. A steering system having a steering gear (11) as claimed in one of the preceding claims, and having an electric motor (18) which is connected in a torque-transmitting manner to the helical gear.
